(19) United States
(12) Patent Application Publication
(10) Pub. No.: US 2018/0203615 A1
(43) Pub. Date: Jul. 19, 2018

(54) STORAGE CONTROL DEVICE, STORAGE CONTROL METHOD, AND COMPUTER READABLE RECORDING MEDIUM

(71) Applicant: TOSHIBA MEMORY CORPORATION, Tokyo (JP)

(72) Inventors: Yoshiki SAITO, Yokohama (JP); Yohei HASEGAWA, Fuchu (JP); Shohei ONISHI, Niiza (JP); Hidenori MATSUZAKI, Fuchu (JP); Shigehiro ASANO, Yokosuka (JP)

(73) Assignee: TOSHIBA MEMORY CORPORATION, Tokyo (JP)

(21) Appl. No.: 15/702,194

(22) Filed: Sep. 12, 2017

(30) Foreign Application Priority Data
Jan. 19, 2017 (JP) 2017-007293

(51) Int. Cl. G06F 3/06

(52) U.S. Cl. CPC G06F 3/0616; G06F 3/0688; G06F 3/0607; G06F 3/0635; G06F 3/0655

(57) ABSTRACT

According to one embodiment, a storage control device has, as a unit of storage, a stripe including one or more chunks being storage areas included in any of a plurality of storages. The storage control device includes a first selector, a divider, and a determiner. The first selector is configured to select a stripe from a plurality of stripes on the basis of the number of one or more pieces of valid first data included in the stripe. The divider is configured to divide the chunk included in the stripe selected by the first selector into a plurality of partial chunks. The determiner is configured to determine the partial chunk that is to be a target of garbage collection on the basis of the number of one or more pieces of the valid first data included in the partial chunk.

### CROSS-REFERENCE TO RELATED APPLICATIONS

This application is based upon and claims the benefit of priority from Japanese Patent Application No. 2017-007293, filed on Jan. 19, 2017; the entire contents of which are incorporated herein by reference.

### FIELD

Embodiments described herein relate generally to a storage control device, a storage control method, and a computer readable recording medium.

### BACKGROUND

In the related art, a storage system including a plurality of block storage devices such as a hard disk drive (HDD) and a solid state drive (SSD) has been known. For example, an all flash array (AFA) including a plurality of SSDs has been known. In general, in a storage system such as an AFA, as the number of times of writing to an SSD increases, the failure rate of the SSD increases. For this reason, the period during which the AFA can be used without exchanging the SSD becomes shorter as the number of times of writing to the SSD increases. As a method of writing data in the storage system, for example, a log-structured method has been known. In the log-structured method, an address of a data write destination is determined as an unwritten area regardless of an address designated by a write command transmitted from a host device. As one of features of the log-structured method, garbage collection (GC) occurs as necessary.

However, in the related art, it was difficult to extend the lifetime of the storage system.

### BRIEF DESCRIPTION OF THE DRAWINGS

FIG. 1 is a diagram illustrating an example of a hardware configuration of a storage control device according to an embodiment;

FIG. 2 is a diagram illustrating an example of a functional configuration of the storage control device according to the embodiment;

FIG. 3 is a diagram illustrating an example of a stripe stored in a storage according to the embodiment;

FIG. 4A is a diagram illustrating an example of a position of a chunk stored in the storage according to the embodiment;

FIG. 4B is a diagram illustrating an example of a position of a chunk stored in the storage according to the embodiment;

FIG. 5 is a flowchart illustrating an example of a write command process according to the embodiment;

FIG. 6 is a diagram illustrating an example of first address information according to the embodiment;

FIG. 7 is a diagram illustrating an example of second address information according to the embodiment;

FIG. 8 is a diagram illustrating an example of stripe information according to the embodiment;

FIG. 9 is a diagram illustrating an example of a stripe including invalid data according to the embodiment;

FIG. 10 is a flowchart illustrating an example of a read command process according to the embodiment;

FIG. 11 is a flowchart illustrating an example of a garbage collection process according to the embodiment;

FIG. 12 is a diagram illustrating an example of a stripe that is to be a target of garbage collection according to the embodiment;

FIG. 13 is a diagram illustrating an example of updating of the stripe information according to the embodiment;

FIG. 14 is a diagram illustrating an example of updating of the stripe information according to the embodiment;

FIG. 15 is a flowchart illustrating an example of a stripe combination process according to the embodiment;

FIG. 16 is a diagram illustrating an example of a stripe according to Modified Example 1 of the embodiment;

FIG. 17 is a flowchart illustrating an example of a garbage collection process according to Modified Example 2 of the embodiment; and

FIG. 18 is a diagram illustrating an example of division of chunks according to Modified Example 2 of the embodiment.

### DETAILED DESCRIPTION

In general, according to one embodiment, a storage control device has, as a unit of storage, a stripe including one or more chunks being storage areas included in any of a plurality of storages. The storage control device includes a first selector, a divider, and a determiner. The first selector is configured to select a stripe from a plurality of stripes on the basis of the number of one or more pieces of valid first data included in the stripe. The divider is configured to divide the chunk included in the stripe selected by the first selector into a plurality of partial chunks. The determiner is configured to determine the partial chunk that is to be a target of garbage collection on the basis of the number of one or more pieces of the valid first data included in the partial chunk.

Exemplary embodiments of a storage control device, a storage control method, and a computer readable recording medium will be described below in detail with reference to the accompanying drawings.

First, an example of a hardware configuration of a storage control device according to an embodiment will be described.

Example of Hardware Configuration

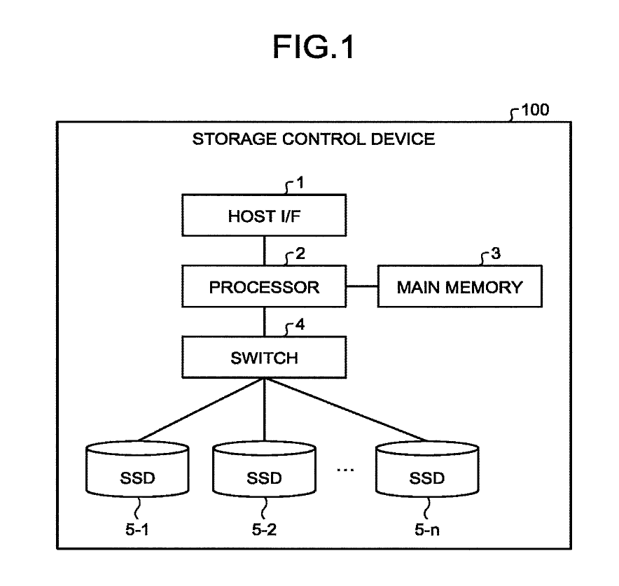

FIG. 1 is a diagram illustrating an example of the hardware configuration of a storage control device 100 according to an embodiment. The storage control device 100 according to the embodiment includes a host interface (I/F) 1, a processor 2, a main memory 3, a switch 4, and SSDs 5-1 to 5-n (n is an integer of 2 or more).

Hereinafter, in the case of not distinguishing between the SSDs 5-1 to 5-n, the SSDs are simply referred to as SSDs 5.

The host I/F 1 receives a request for a write command, a read command, a trim command, a shutdown command, or the like from a host device. The host device may be arbitrary. The host device is, for example, a personal computer, a smart device, and the like.

The write command is a command to write first data in the SSDs 5. The write command includes the first data and a first address specifying the first data. The first data may be arbitrary. The first data is, for example, user data used by a user of the host device.

The read command is a command to read the first data from the SSD 5. The read command includes the first address.

The trim command is a request to invalidate the first data specified by the first address designated by the host device. The first data specified by the first address designated by the trim command is erased in a case where garbage collection is performed.

The shutdown command is a request to shut down the storage control device 100.

The processor 2 reads a program from an auxiliary storage device such as the SSD 5 and executes the program.

The main memory 3 is a storage area used as a work area by the processor 2.

The switch 4 connects the processor 2 and the SSDs 5-1 to 5-n. Alternatively, in a case where the number of SSDs 5 is small and the processor 2 and the SSDs 5 can be directly connected thereto, the switch 4 may not be provided.

The SSDs 5 store data. The data to be stored in the SSDs 5 are, for example, the first data, the second data, the control data, and the like above described.

The second data is data for restoring the first data. The format of the second data may be arbitrary. The second data is, for example, a redundant format, a reed-solomon (RS) code, a Hamming code, or the like used in redundant array of inexpensive disks (RAID)-1 to RAID-6. In addition, for example, the second data may simply be a copy of the first data.

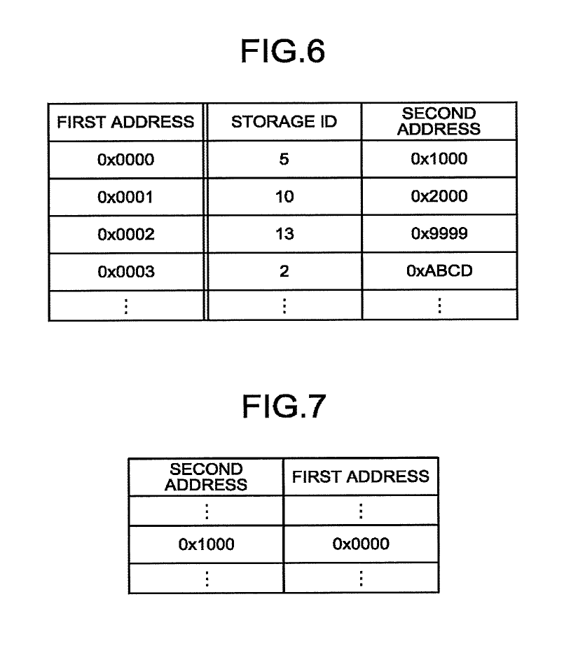

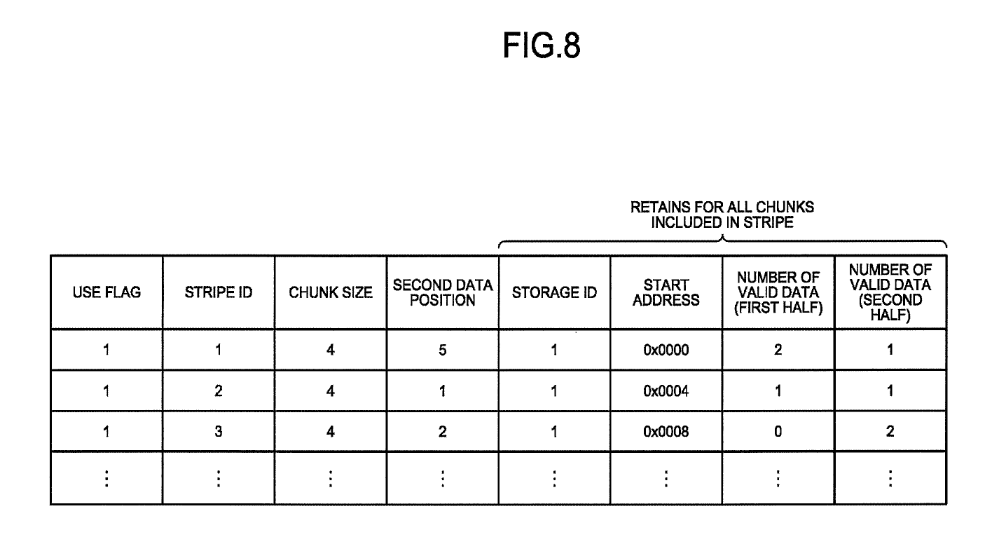

The control data is a table or the like used for controlling the storage control device 100. The control data is, for example, first address information (refer to FIG. 6), second address information (refer to FIG. 7), stripe information (refer to FIG. 8), or the like.

In addition, in the example of FIG. 1, a case where the auxiliary storage device is the SSD 5 is illustrated, but the auxiliary storage device may be arbitrary. The auxiliary storage device may be, for example, an HDD or the like.

Next, an example of a functional configuration of the storage control device 100 according to the embodiment will be described.

Example of Functional Configuration

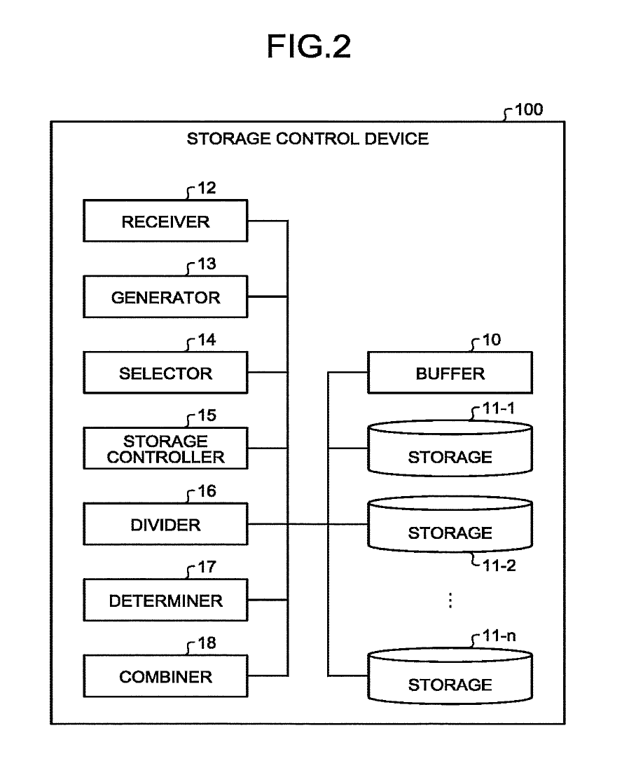

FIG. 2 is a diagram illustrating an example of the functional configuration of the storage control device 100 according to the embodiment. The storage control device 100 according to the embodiment includes a buffer 10, storages 11-1 to 11-n, a receiver 12, a generator 13, a selector 14, a storage controller 15, a divider 16, a determiner 17, and a combiner 18.

In FIG. 2, the outline of operations of each functional block will be described. The functional block illustrated in FIG. 2 is an example, and other functional configurations may be used. For example, processes performed by one functional block may be changed so as to be performed by a plurality of functional blocks. The details of the operations of each functional block will be described with reference to a flowchart to be described later.

Outline of Operations

The buffer 10 temporarily stores data that is to be a target of processing. The buffer 10 is realized by, for example, the main memory 3. The buffer 10 stores, for example, the first data designated by the write command received by the receiver 12.

The storages 11-1 to 11-n store data. The storages 11-1 to 11-n are realized by, for example, the SSDs 5-1 to 5-n. The data stored in the storages 11-1 to 11-n are, for example, the first data, the second data, the control data, and the like. Hereinafter, in the case of not distinguishing between the storages 11-1 to 11-n, the storages are simply referred to as storages 11.

The receiver 12 receives a request for a write command, a read command, a trim command, a shutdown command, or the like from the host device.

The generator 13 generates a stripe which is a unit of storing one or more pieces of first data and one or more pieces of second data. The stripe includes one or more chunks included in any of the plurality of storages 11. The chunk is a storage area having a predetermined size. Identification information which identifies an unused stripe is stored in the buffer 10, the storage 11, and the like by a method such as first in, first out (FIFO). Identification information which identifies a stripe is, for example, a stripe ID or the like.

In addition, when the process of storing one or more pieces of first data in the storage 11 is to be performed, the generator 13 generates the above-mentioned one or more pieces of the second data from one or more pieces of the first data.

When one or more pieces of the first data and one or more pieces of the second data are to be stored in the storage 11, the selector 14 selects a stripe that is to store one or more pieces of the first data and one or more pieces of the second data. The selector 14 sequentially selects a stripe that is to store one or more pieces of the first data and one or more pieces of the second data from the stripes identified by the identification information of unused stripes stored in, for example, the head of FIFO.

In addition, when a garbage collection process of the storage 11 is to be performed, the selector 14 selects a stripe that is to be a target of garbage collection.

In addition, when a stripe combination process is to be performed, the selector 14 selects a plurality of stripes of which the chuck sizes are equal to or smaller than a threshold value (fourth threshold value) and a stripe of copy destination of which the chuck size is equal to or larger than a threshold value (fifth threshold value).

Example of Stripe

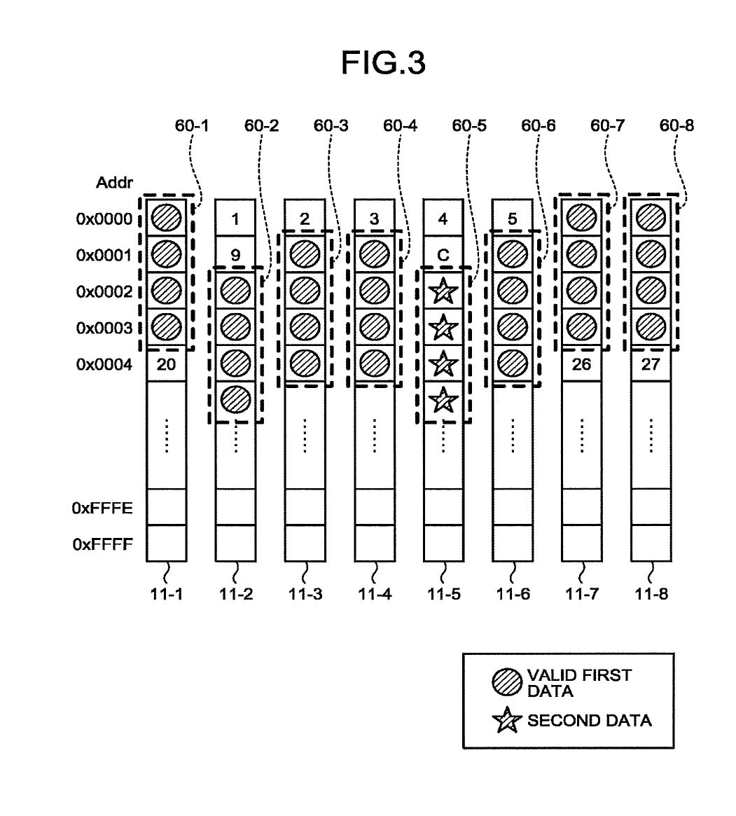

FIG. 3 is a diagram illustrating an example of a stripe stored in the storage 11 according to the embodiment. In the example of FIG. 3, the case is illustrated where the stripe includes chunks 60-1 to 60-8. Each chunk is stored in one of the plurality of storages 11. For example, the chunk 60-1 is stored in the storage 11-1. The chunk size may be arbitrary. In the example in FIG. 3, the case is illustrated where the chunk size is four.

In the example of FIG. 3, one or more pieces of first data are stored in the chunks 60-1 to 60-4 and the chunks 60-6 to 60-8. In the example of FIG. 3, the second data is stored in the chunk 60-5.

In addition, each chunk included in the stripe may not be stored by consecutively using the plurality of adjacent storages 11. A combination of the storages 11 that are to store the chunks may be arbitrary.

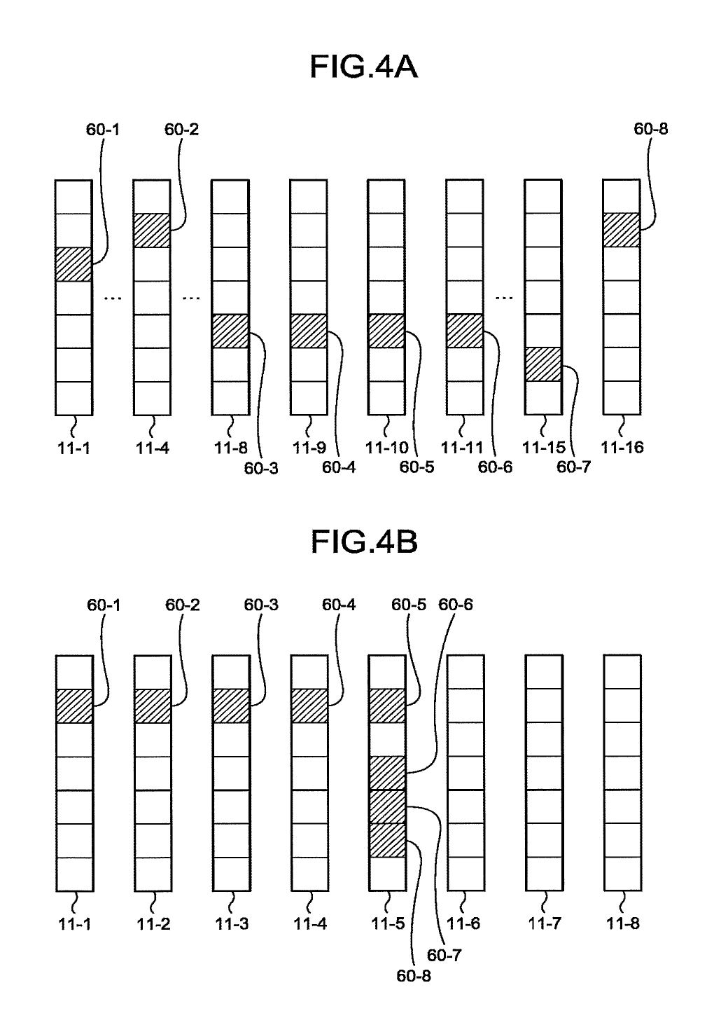

FIG. 4A is a diagram illustrating an example of positions of the chunks stored in the storages 11 according to the embodiment. In the example of FIG. 4A, the case is illustrated where the chunk 60-1 is stored in the storage 11-1, the chunk 60-2 is stored in the storage 11-4, the chunk 60-3 is stored in the storage 11-8, the chunk 60-4 is stored in the storage 11-9, the chunk 60-5 is stored in the storage 11-10, the chunk 60-6 is stored in the storage 11-11, the chunk 60-7 is stored in the storage 11-15, and the chunk 60-8 is stored in the storage 11-16.

FIG. 4B is a diagram illustrating another example of positions of the chunks stored in the storages 11 according to the embodiment. In the example of FIG. 4B, the case is illustrated where the chunk 60-1 is stored in the storage 11-1, the chunk 60-2 is stored in the storage 11-2, the chunk 60-3 is stored in the storage 11-3, the chunk 60-4 is stored in the storage 11-4, and the chunks 60-5 to 60-8 are stored in the storage 11-5.

Returning to FIG. 2, the storage controller 15 stores one or more pieces of the first data and one or more pieces of the second data in the chunks included in the stripe selected by the selector 14.

The chunks for storing one or more pieces of the second data may be arbitrary. The storage controller 15 determines at least one of the chunks for storing one or more pieces of the first data and the chunks for storing one or more pieces of the second data for example on the basis of the state of the storages 11-1 to 11-n.

The states of the storages 11-1 to 11-n can be, for example, the total write capacities of the storages 11-1 to 11-n. Since the second data is required to be updated every time when the first data included in the same stripe as the second data is updated, in some cases, the update frequency of the second data may be higher than the first data. For this reason, the storage controller 15 can further extend the lifetime of the storages 11-1 to 11-n by writing the second data in the storages 11 with smaller total write capacities.

In addition, the states of the storages 11-1 to 11-n can be, for example, the write ratios of the storages 11-1 to 11-n. The write ratio is a ratio of the total write capacity of the storage 11 to the capacity of the storage 11. For example, in a case where the capacity of the storage 11 is 128 GB and the total write capacity is 64 GB, the write ratio is 50%. In addition, for example, in a case where the capacity of the storage 11 is 128 GB and the total write capacity is 512 GB, the write ratio is 400%.

The lifetime of the storage system becomes longer in the state where all the storages 11 included in the storage system are exhausted at the same speed than in the state where only the specific storage 11 included in the storage system tends to be exhausted.

For this reason, in a case where the capacities of the storages 11-1 to 11-n are the same, the storage controller 15 can use the total write capacity as the states of the storages 11-1 to 11-n. In addition, in a case where the capacities of the storages 11-1 to 11-n are not the same, the storage controller can use the write ratios as the states of the storages 11-1 to 11-n.

For example, in a case where the capacity of the storage 11-1 is 128 GB, the capacity of the storage 11-2 is 512 GB, and the size of the data that is to be an object of writing is 128 GB, it is possible to ease the increase of the write ratio by writing the data in the storage 11-2 rather than writing the data in the storage 11-1. The storage controller 15 can extend the lifetime of the storage system by determining at least one of the chunks for storing one or more pieces of the first data and a chunk for storing one or more pieces of the second data on the basis of the write ratio. The storage controller 15 determines the chunk included in the storage 11 of which write ratio is smaller than that of the other storages 11 as a chunk that stores one or more pieces of the second data.

In addition, for example, the storage controller 15 can randomly determines at least one of the chunk that stores one or more pieces of the first data and the chunk that stores one or more pieces of the second data. As a result, it is possible to prevent the second data having the update frequency higher than that of the first data from being stored in the same storage 11 at all times, so that it is possible to further extend the lifetime of the storages 11-1 to 11-n.

The divider 16 divides the chunk into a plurality of partial chunks. The number of divisions may be arbitrary. In the description of the embodiment, for the simplicity, a case where the number of divisions is two will be described as an example. For example, in a case where the chunk size is four and the number of divisions is two, the divider 16 divides the chunk having a chunk size of four into two partial chunks having a chunk size of two.

The determiner 17 determines the partial chunk that is to be a target of garbage collection on the basis of the number of valid data included in the partial chunk. The valid data indicates valid first data. Details of the valid data will be described later.

The combiner 18 copies the valid data included in the plurality of stripes including the chunk of which the chuck size is equal to or smaller than a threshold value (fourth threshold value) to an unused stripe including the chunk of which the chuck size is equal to or larger than a threshold value (fifth threshold value). Then, the combiner 18 deletes the plurality of stripes. Therefore, the combiner combines the plurality of stripes with one stripe.

The operations of each functional block will be described in detail below with reference to a flowchart. First, an example of a write command process according to the embodiment will be described.

Example of Write Command Process

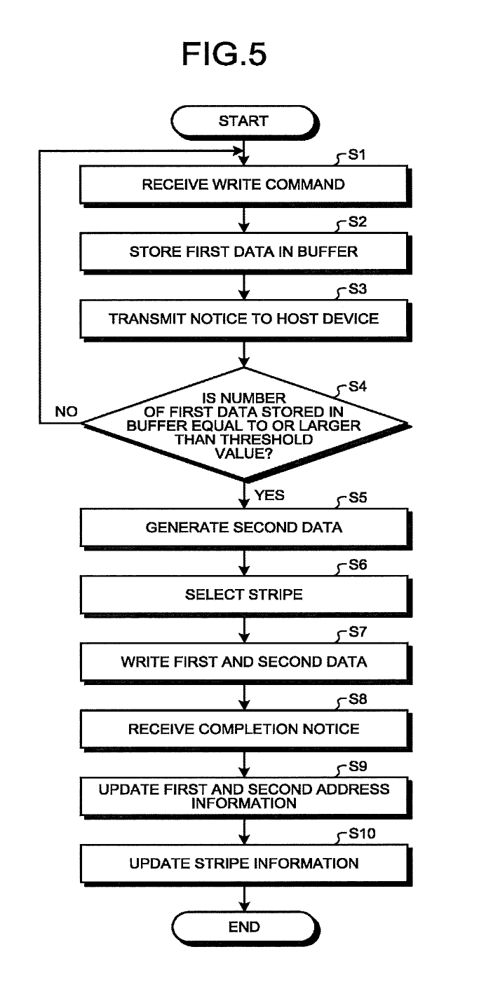

FIG. 5 is a flowchart illustrating an example of the write command process according to the embodiment. First, the receiver 12 receives a write command from the host device (step S1). Next, the receiver 12 stores, in the buffer 10, the first data designated by the write command received by the process of step S1 (step S2). Next, the receiver 12 transmits, to the host device, a notice indicating that the reception of the write command has been successful (step S3).

Next, the generator 13 determines whether or not the number of the first data (or the data size of the first data stored in the buffer 10) stored in the buffer 10 is equal to or larger than a threshold value (step S4). The threshold value can be determined arbitrarily. The threshold value is determined on the basis of, for example, the data size necessary to generate one stripe. In a case where the number of first data stored in the buffer 10 is not equal to or larger than the threshold value (step S4, No), the process returns to step S1.

In a case where the number of first data stored in the buffer 10 is equal to or larger than the threshold value (step S4, Yes), the generator 13 generates one or more pieces of the second data for restoring the first data from one or more pieces of the first data (step S5).

Next, the selector 14 selects a stripe that is to store one or more pieces of the first data and one or more pieces of the second data (step S6).

Next, the storage controller 15 writes one or more pieces of the first data and one or more pieces of the second data in the chunk included in the stripe selected by the process of step S6 (step S7).

Next, the storage controller 15 receives a completion notice indicating the completion of writing from each SSD5 (step S8).

Next, the storage controller 15 updates the first address information and the second address information (step S9). Herein, examples of the first address information and the second address information will be described.

Example of First Address Information

FIG. 6 is a diagram illustrating an example of the first address information according to the embodiment. The first address information according to the embodiment stores the first address, the storage ID, and the second address, associated with each other. The first address and the second address are, for example, addresses of a logical block addressing (LBA) system.

The first address is an address of the first data designated by the write command received from the host device. In the host device, the storage position of the first data is specified by the first address.

The storage ID is identification information which identifies the storage 11. The second address is an address indicating a position in the storage 11 with the storage ID, where the first data is stored. In the storage control device 100, the storage position of the first data is specified by the storage ID and the second address.

In the example of FIG. 6, for example, the first data specified by the first address 0x0000 is stored in the second address 0x1000 of the storage 11-5 having a storage ID of 5.

With the first address information described above, it is possible to associate the first address used in the host device, the storage ID used in the storage control device 100, and the second address.

In addition, in the example of FIG. 6, the first address information having a table structure has been described, but the data structure of the first address information may be arbitrary. The data structure of the first address information may be, for example, a tree structure.

Example of Second Address Information

FIG. 7 is a diagram illustrating an example of second address information according to the embodiment. The second address information includes a second address and a first address. The second address information is stored for each storage 11. The example of FIG. 7 illustrates an example of the second address information of the storage 11-5. The example of FIG. 7 illustrates that an area specified by the second address 0x1000 stores the first data specified by the first address 0x0000.

The storage controller 15 updates the first address information (refer to FIG. 6) and the second address information (refer to FIG. 7) every time when the first data designated by the write command is to be written in the storage 11.

Next, returning to FIG. 5, the storage controller 15 updates the stripe information (step S10). Herein, an example of the stripe information will be described.

Example of Stripe Information

FIG. 8 is a diagram illustrating an example of the stripe information according to the embodiment. The stripe information according to the embodiment includes a use flag, a stripe ID, a chunk size, a second data position, a storage ID, a start address, the number of valid data (first half), and the number of valid data (second half).

The use flag is information indicating whether or not a stripe is used. For example, a case where the use flag is 0 indicates that the stripe is not used, and a case where the use flag is 1 indicates that the stripe is used. The storage controller 15 updates the use flag of the stripe selected in step S6 from 0 to 1.

The stripe ID is identification information which identifies the stripe.

The chunk size is the size of a chunk included in the stripe.

The second data position is information indicating the storage 11 in which the second data is stored. In the example of FIG. 8, the information indicating the storage 11 in which the second data is stored is a storage ID that identifies the storage 11.

The storage ID, the start address, the number of valid data (first half), and the number of valid data (second half) indicate the storage position of the chunk and the number of valid data included in the chunk. The storage ID, the start address, the number of valid data (first half), and the number of valid data (second half) are retained corresponding to the number of chunks included in the stripe. The number of valid data is the number of valid data described above.

The storage ID is identification information which identifies the storage 11 to which the chunk is to be allocated.

The start address is an address indicating the storage area at the head of the chunk.

The number of valid data (first half) indicates the number of valid data in the first half of the area that stores the chunk. In the example where the stripe ID is 1 in FIG. 8, since the chunk size is four, the start address is 0x0000, and the number of valid data (first half) is two, it is illustrated that the first data stored in 0x0000 and the first data stored in 0x0001 are valid data.

The number of valid data (the second half) indicates the number of valid data in the second half of the area that stores the chunk. In the example with the stripe ID of 1 in FIG. 8, since the chunk size is four, the start address is 0x0000, and the number of valid data (second half) is one, it is illustrated that one of the first data stored in 0x0002 and 0x0003 is valid data and the other invalid data. The invalid data indicates invalid first data.

Herein, details of the valid data and the invalid data will be described. The first data stored in the SSD5 wrote by the process of step S7 are all valid data. However, in a case where the first data designated by the first address specified by the write command has already been stored in the storage 11 (in the case of updating the first data or in the case of moving the first data by garbage collection described below), the before-updating first data included in the stripe already stored in the storage 11 is invalid data.

The storage controller 15 updates the stripe information of the stripe that stores the before-updating first data. Specifically, in a case where the before-updating first data is stored in the first half of the chunk, the storage controller 15 reduces the number of valid data (first half), and in a case where the before-updating first data is stored in the second half of the chunk, the storage controller reduces the number of valid data (second half).

It can be specified from the first address information (refer to FIG. 6) and the second address information (refer to FIG. 7) whether or not the first data is valid data. For example, in a case where the first address information is in the state illustrated in FIG. 6 and the second address information is in the state illustrated in FIG. 7, a case where the first data specified by the first address 0x0000 is updated will be described in detail below.

For example, in a case where the after-updating first data specified by the first address 0x0000 is stored in the second address 0x1234 of the storage 11-5 with the storage ID of 5, the storage controller 15 updates the first line of the first address information in FIG. 6 from {0x0000, 5, 0x1000} to {0x0000, 5, 0x1234}. In addition, the storage controller 15 writes {0x1234, 0x0000} in the second address information of the storage 11-5 in FIG. 7.

Since the first address information and the second address information are updated as described above, the valid data and the invalid data can be specified from the first address information and the second address information.

Specific Example of Valid Data

The first address 0x0000 acquired from the second address information of the storage 11-5 by using the second address 0x1234 and the storage ID and the second address {5, 0x1234} acquired from the first address information by using the first address 0x0000 are matched. Therefore, the first data stored in the second address 0x1234 of the storage 11-5 is valid data.

Specific Example of Invalid Data

The first address 0x0000 acquired from the second address information of the storage 11-5 by using the second address 0x1000 and the storage ID and the second address {5, 0x1234} acquired from the first address information by using the first address 0x0000 are not matched. Therefore, the first data stored in the second address 0x0000 of the storage 11-5 is invalid data.

As another example of the invalid data, the first data specified by the first address designated by the above-mentioned trim command, for example, may be exemplified.

Example of Stripe Including Invalid Data

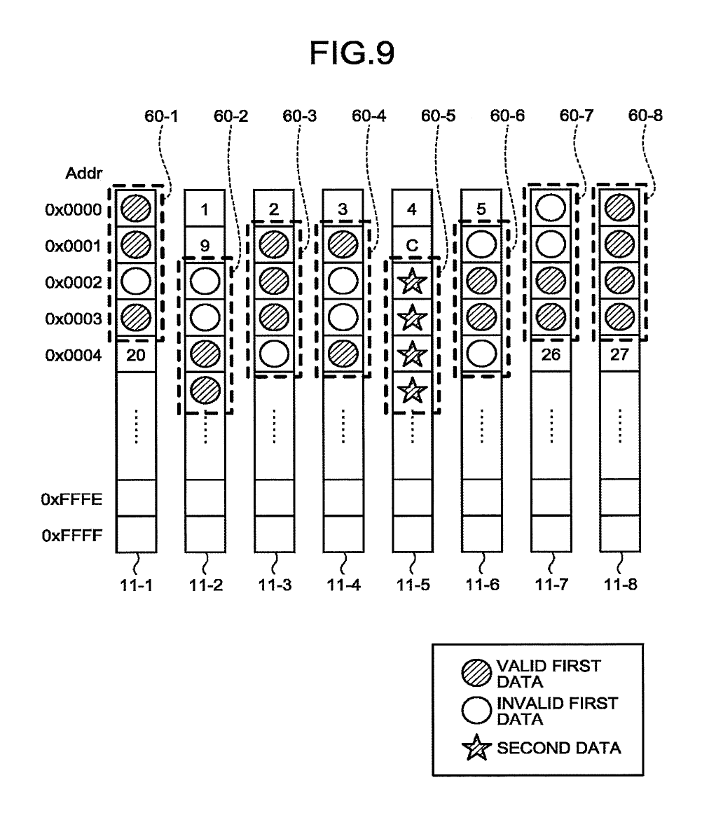

FIG. 9 is a diagram illustrating an example of a stripe including invalid data according to the embodiment. For example, in the chunk 60-1, the first data specified by the second address 0x0000 is valid data, the first data specified by the second address 0x0001 is valid data, the first data specified by the second address 0x0002 is invalid data, and the first data specified by the second address 0x0003 is valid data. Therefore, the number of valid data (first half) of the chunk 60-1 is two. The number of valid data (the second half) of the chunk 60-1 is one.

Next, an example of a read command process according to the embodiment will be described.

Example of Read Command Process

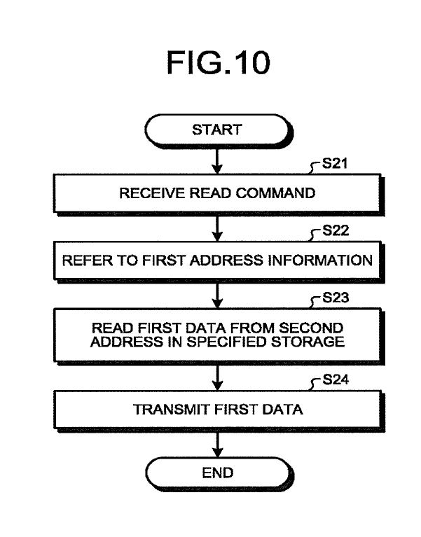

FIG. 10 is a flowchart illustrating an example of a read command process according to the embodiment. First, the receiver 12 receives a read command including a first address from the host device (step S21).

Next, the storage controller 15 refers to the first address information by using the first address included in the read command received by the process of step S21 (step S22). The storage controller 15 specifies the storage 11 that stores the first data specified by the first address and the second address of the storage 11 by the process of step S22.

Next, the storage controller 15 reads the first data from the second address of the storage 11 specified by the process of step S22 (step S23).

Next, the receiver 12 transmits the first data read by the process of step S23 as a response to the read command received by the process of step S21 (step S24).

Next, an example of a garbage collection process according to the embodiment will be described.

Example of Garbage Collection Process

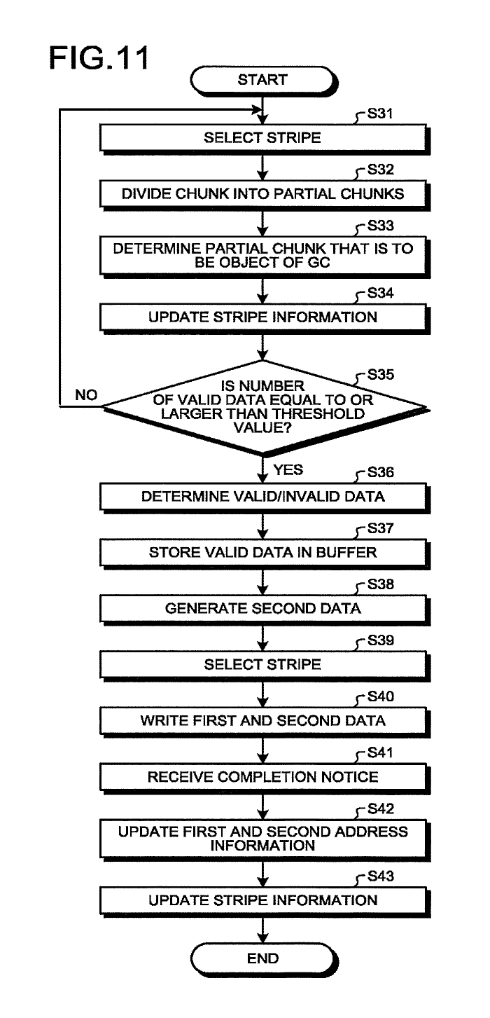

FIG. 11 is a flowchart illustrating an example of the garbage collection process according to the embodiment. First, the selector 14 selects a stripe that is to be a target of garbage collection on the basis of the number of valid data included in the stripe (step S31). By referring to, for example, the stripe information (refer to FIG. 8), the selector 14 selects a stripe of which the number of valid data included in the stripe is equal to or smaller than a threshold value (first threshold value). By selecting the stripe of which the number of valid data is equal to or smaller than the threshold value, the selector 14 can ease the increase of the number of valid data to be moved during execution of garbage collection. Note that the selector 14 may select the stripe of which the number of valid data is the smallest.

Next, the divider 16 divides the chunk included in the stripe selected by the process of step S31 into partial chunks (step S32). Herein, with respect to chunk division, a case where the chunk included in the stripe of FIG. 9 is divided into two partial chunks will be described in detail as an example. The divider 16 divides the chunk 60-1 into the first half partial chunk and the second half partial chunk. The first half partial chunk is a partial chunk including the second addresses 0x0000 and 0x0001. The second half partial chunk is a partial chunk including the second addresses 0x0002 and 0x0003. Similarly, the divider 16 also divides each of the chunks 60-2 to 60-8 into the first half partial chunk and the second half partial chunk.

Next, the determiner 17 determines a partial chunk that is to be a target of garbage collection on the basis of the number of valid data included in the partial chunk (step S33). Specifically, the determiner 17 refers to the number of valid data (first half) and the number of valid data (second half) included in the stripe information of the stripe selected by the process of step S31. The number of valid data (first half) indicates the number of valid data included in the first half partial chunk. The number of valid data (the second half) indicates the number of valid data included in the second half partial chunk. The determiner 17 determines the partial chunk having a smaller number of valid data as a target of garbage collection. In addition, in a case where the numbers of valid data included in the two partial chunks are the same, the determiner 17 determines one of the partial chunks as a target of garbage collection.

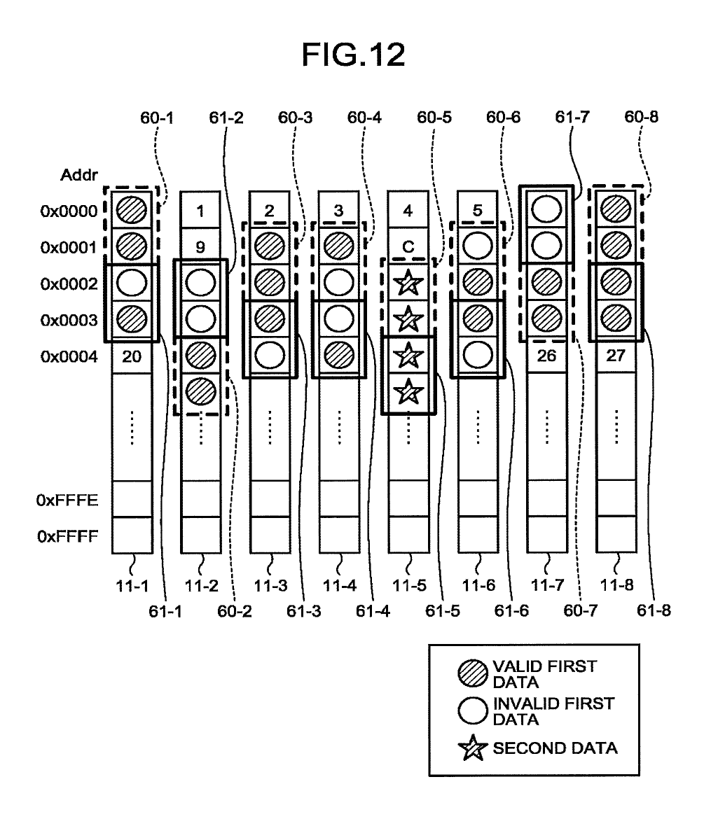

FIG. 12 is a diagram illustrating an example of a stripe that is to be a target of garbage collection according to the embodiment. In the example of FIG. 12, the stripe including partial chunks 61-1 to 61-8 is a stripe that is to be a target of garbage collection.

Next, returning to FIG. 11, the storage controller 15 updates the stripe information (step S34). Specifically, the storage controller 15 updates the stripe information of the stripe selected by the process of step S31 as the stripe information of the stripe including the partial chunk that is not to be a target of garbage collection and the stripe information of the stripe including the partial chunk that is to be a target of garbage collection.

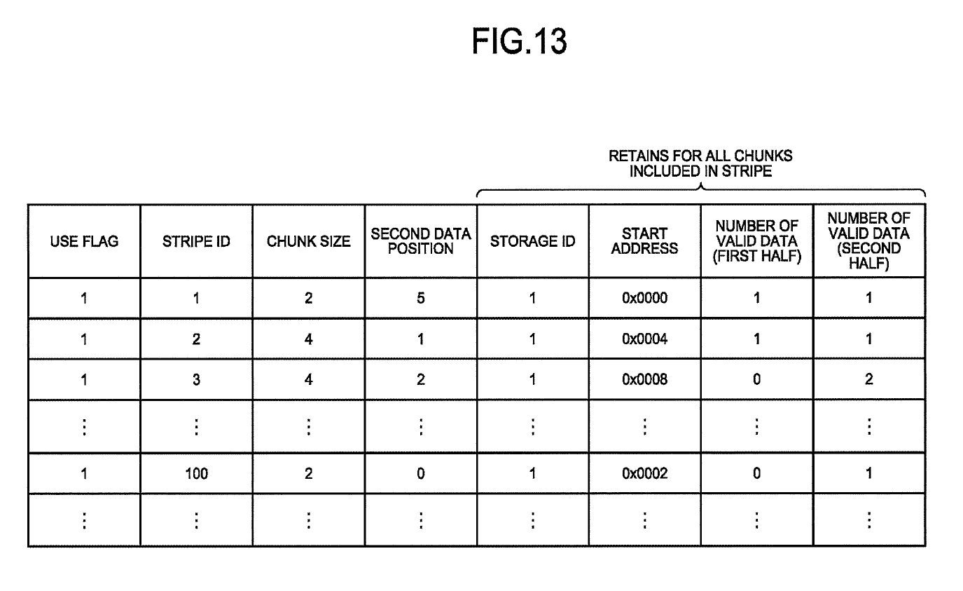

FIG. 13 is a diagram illustrating an example of updating the stripe information according to the embodiment. In the example of FIG. 13, the case is illustrated where a stripe having a stripe ID of 1 included in the stripe information of FIG. 8 is divided into a stripe having a stripe ID of 1 and a stripe having a stripe ID of 100. The stripe having a stripe ID of 1 is a stripe including the partial chunk that is not to be a target of garbage collection. A stripe having a stripe ID of 100 is a stripe including the partial chunk that is to be a target of garbage collection.

Specifically, the storage controller 15 updates the chunk size of the stripe information of the stripe having a stripe ID of 1 from four to two, updates the number of valid data (first half) from two to one, and updates the number of valid data (second half) from one to one (in this case, there is no change in the number of valid data (the second half)). In addition, the storage controller 15 newly generates {1, 100, 2, 0, 1, 0x0002, 0, 1} as the stripe information of the stripe having a stripe ID of 100. In addition, the stripe ID of the newly generated stripe is selected from the unused number.

Next, returning to FIG. 11, the storage controller 15 determines whether or not the number of valid data included in the stripe that is to be a target of garbage collection (the number of valid data included in all the partial chunks that are to be targets of GC selected by the process of step S33 by repeating the processes of step S31 to step S35) is equal to or larger than a threshold value (step S35). In addition, the threshold value may be determined arbitrarily. The threshold value is determined on the basis of the data size necessary to generate one stripe, for example, by the valid data that is to be moved by garbage collection.

In a case where the number of valid data is not equal to or larger than the threshold value (step S35, No), the process returns to step S31.

In a case where the number of valid data is equal to or larger than the threshold value (step S35, Yes), the storage controller 15 determines valid/invalid data included in the partial chunk determined by the process of step S36 (step S36). Next, as the flow of the step S23 and S24 in the above-mentioned FIG. 10, the storage controller 15 reads the valid data from SSD5, and stores the valid data in buffer 5 (step S37). The description of the processes of steps S38 to S42 is the same as the description of steps S5 to S9 in FIG. 5.

Next, the storage controller 15 updates the stripe information (step S43). Specifically, the storage controller 15 updates the stripe information of the stripe including the partial chunk that is to be a target of garbage collection and newly generates the stripe information of the stripe including valid data that is moved by garbage collection.

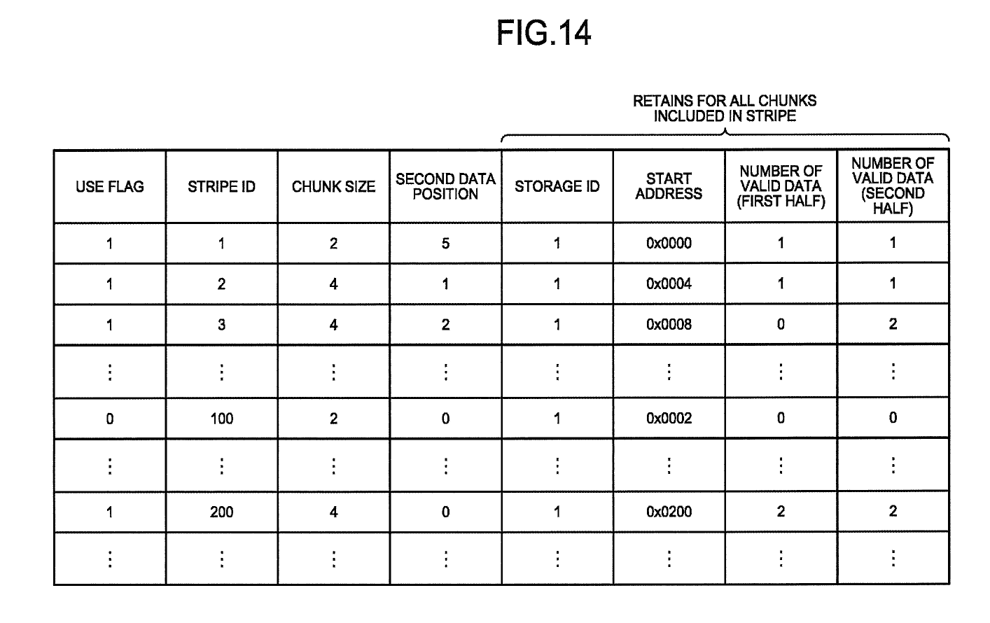

FIG. 14 is a diagram illustrating an example of updating the stripe information according to the embodiment. In the example of FIG. 14, the case is illustrated where the stripe information of the stripe having a stripe ID of 100 included in the stripe information of FIG. 13 is updated. In addition, in the example of FIG. 14, as an example of the stripe information of the stripe including valid data that is moved by garbage collection, the case illustrated where stripe information of a stripe having a stripe ID of 200 is newly generated.

Specifically, the storage controller 15 updates the use flag of the stripe information of the stripe having a stripe ID of 100 from 1 to 0 and updates the number of valid data (second half) from 1 to 0. In addition, the storage controller 15 newly generates {1, 200, 4, 0, 1, 0x0200, 2, 2} as the stripe information of the stripe having a stripe ID of 200.

As described in step S33 of FIG. 11, in the storage controller 15 according to the embodiment, the determiner 17 determines the partial chunk that is to be a target of garbage collection on the basis of the number of valid data included in the partial chunk. Therefore, it is possible to ease the increase of the number of valid data to be moved during execution of garbage collection, and to further extend the lifetime of the storage 11.

Next, an example of a stripe combination process will be described.

Example of Combination Process

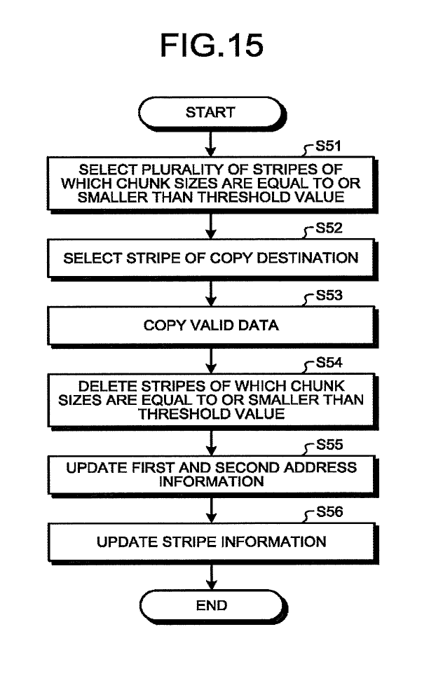

FIG. 15 is a flowchart illustrating an example of the stripe combination process according to the embodiment. First, the selector 14 selects a plurality of stripes of which the chuck sizes are equal to or smaller than a threshold value (fourth threshold value) (step S51). Note that the selector 14 may select a plurality of stripes of which the chuck sizes are the smallest.

Next, the selector 14 selects a stripe of copy-destination of valid data included in the stripe selected by the process of step S51 (step S52). The selector 14 selects a stripe of which, for example, the chuck size is equal to or larger than a threshold value (fifth threshold value). In addition, the selector 14 selects a stripe identified by identification information of an unused stripe, for example, stored at the head of a FIFO.

Next, the combiner 18 copies valid data included in the plurality of stripes selected by the process of step S51 to the stripe selected by the process of step S52 (step S53).

Next, the combiner 18 deletes a plurality of stripes of which the chuck size selected by the process of step S51 is equal to or smaller than the threshold value (fourth threshold value) (step S54).

Next, the storage controller 15 updates the first address information (refer to FIG. 6) and the second address information (refer to FIG. 7) of the first data moved by the process of step S53 (step S55).

Next, the storage controller 15 updates the stripe information (refer to FIG. 8) (step S56). Specifically, by updating the use flags of the plurality of stripes deleted by the combination of the stripes from 1 to 0, the storage controller 15 deletes the stripe information of the plurality of stripes. In addition, the storage controller 15 generates the stripe information of the stripes of which use has been started by the combination of the stripes.

By the process of step S56, it is possible to prevent an increase in the data size of the stripe information. In addition, in a case where the table size of the stripe information is fixed, it is possible to prevent an increase in the number of entries stored as the stripe information.

The selector 14 may select stripes that are to be objects of combination by a method other than the above-described method of step S51. The selector 14 may select two stripes each including, for example, two adjacent chunks that are included in the same storage 11 and have chuck sizes, each of which is equal to or smaller than the threshold value.

As described above, in the storage control device 100 according to the embodiment, the selector 14 selects the stripes from the plurality of stripes on the basis of the number of valid data included in the stripes. The divider 16 divides the chunk included in the stripe selected by the selector 14 into a plurality of partial chunks. Then, the determiner 17 determines a partial chunk that is to be a target of garbage collection on the basis of the number of valid data included in the partial chunk.

As a result, according to the storage control device 100 according to the embodiment, movement of the first data of which updating (overwriting) has not been processed for a long time is less likely to occur, so that it is possible to ease the increase of the number of times of writing in the storage system (storages 11-1 to 11-n). Therefore, it further extends the lifetime of the storage system.

In the above description of the embodiment, for the simplicity, a case where the chunk is divided into two partial chunks by the divider 16 has been described, but the number of divisions may be arbitrary. For example, in a case where the number of divisions is four, the number of valid data (first half) and the number of valid data (second half) of the stripe information of FIG. 8 are changed into the number of valid data of the four storage areas.

For example, in a case where the chunk size of the stripe is 20 and the start address is 0x0000, the four storage areas are a first storage area of 0x0000 to 0x0004, a second storage area of 0x0005 to 0x0009, a third storage area of 0x000A to 0x000E, and a fourth storage area of 0x000F to 0x0013.

In the above description of the embodiment, for the simplicity, a case where the chunk sizes of the partial chunks after division are the same has been described, but the chunk sizes of the partial chunks may be arbitrary. For example, in the case of dividing a chunk having a chunk size of four into two partial chunks, the chunk size of the stripe information in FIG. 8 is changed into the chunk size corresponding to each partial chunk. For example, in a case where the chunk size of the stripe is 16, the start address is 0x0000, and the chuck is divided into two partial chunks having chunk sizes of 12 and four, respectively, the respective storage areas are 0x0000 to 0x000B and 0x000C to 0x000F.

In a case where the chunk is divided into four partial chunks by the divider 16, the number of partial chunks determined as a target of garbage collection by the determiner 17 may be arbitrary. The determiner 17 may determine the partial chunk of which the number of valid data included in the partial chunk is smaller than the number of the valid data included in the other partial chunks as a partial chunk that is to be a target of garbage collection. In addition, for example, the determiner 17 may determine the partial chunk of which the number of valid data included in partial chunks is equal to or smaller than a threshold value (second threshold) among the plurality of partial chunks as a partial chunk that is to be a target of garbage collection.

In addition, the number of partial chunks that are to be targets of garbage collection determined by the determiner 17 is not limited to one, and the number may be arbitrary. For example, the determiner 17 may determine three partial chunks that are to be targets of garbage collection among the four partial chunks acquired by dividing the chunk.

In addition, even in a case where the number of valid data for every four storage areas is retained in the stripe information, by referring to the number of valid data in the first and second storage areas and the number of valid data in the third and fourth storage areas, it is possible to cope with the case the chunk is divided into two partial chunks.

### Modified Example 1 of Embodiment

Next, Modified Example 1 of the embodiment will be described. In the description of Modified Example 1 of the embodiment, the components similar to those of the embodiment will be omitted, and the components different from those of the embodiment will be described. In Modified Example 1 of the embodiment, a case where the minimum unit is determined as the data size of the partial chunk will be described.

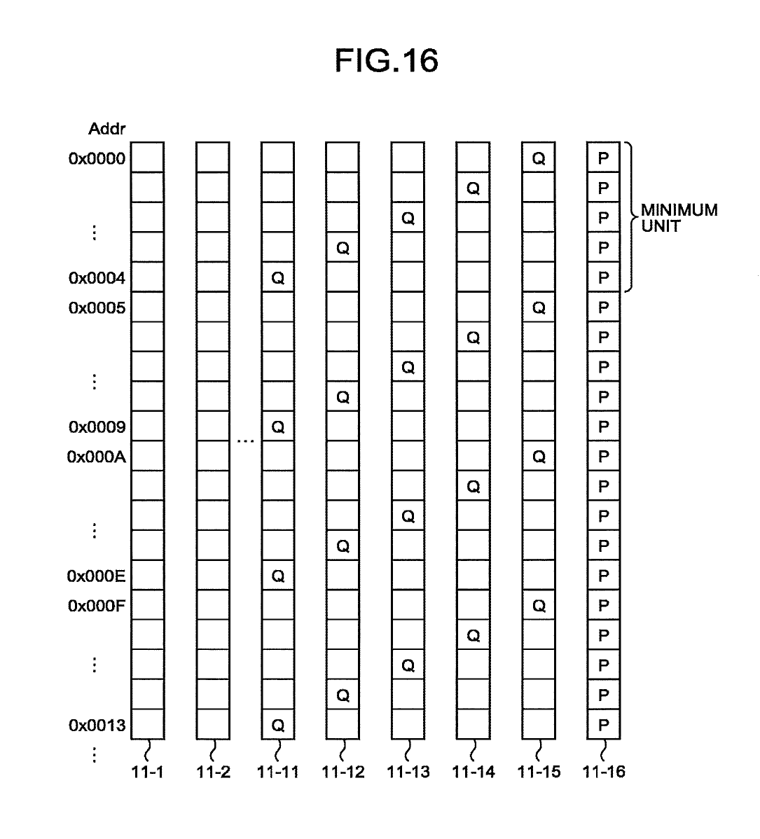

FIG. 16 is a diagram illustrating an example of a stripe according to Modified Example 1 of the embodiment. In the example in FIG. 16, the case is illustrated where a stripe having a chunk size of 20. The stripe of FIG. 16 includes a plurality of second data P and a plurality of second data Q. By storing the second data P and Q in the storages 11-11 to 11-16 as illustrated in FIG. 16, the first data can be restored even if the two storages fail. However, if the positional relationship between the second data P and Q illustrated in FIG. 16 collapses, the first data cannot be restored. Therefore, in a case where the size of the partial chunk is less than a minimum unit, the divider 16 according to Modified Example 1 of the embodiment does not divide the chunk. In the example of FIG. 16, the threshold value (third threshold value) indicating the minimum unit of the size of the partial chunk is 5. Therefore, in the example of FIG. 16, the divider 16 can divide the chunk into, for example, two partial chunks or four partial chunks, but the divider cannot divide the chunk into five or more partial chunks.

In addition, in the example of FIG. 16, for the simplicity, the case is illustrated where the start addresses of the chunks included in each storage 11 are coincident, but the start addresses of the chunks included in each storage 11 may be different.

In the storage control device 100 according to Modified Example 1 of the embodiment, the divider 16 divides the chunk into the plurality of partial chunks while maintaining the positional relationship of the plurality of second data. Therefore, in the storage control device 100 according to Modified Example 1 of the embodiment, when the predetermined number of storages 11 fails, it is possible to restore the first data, and it is possible to further extend the lifetime of the storages 11-1 to 11-n.

### Modified Example 2 of Embodiment

Next, Modified Example 2 of the embodiment will be described. In the description of Modified Example 2 of the embodiment, the components similar to those of the embodiment will be omitted, and the components different from those of the embodiment will be described. In Modified Example 2 of the embodiment, a case where the divider 16 performs several times of the division process on one stripe will be described.

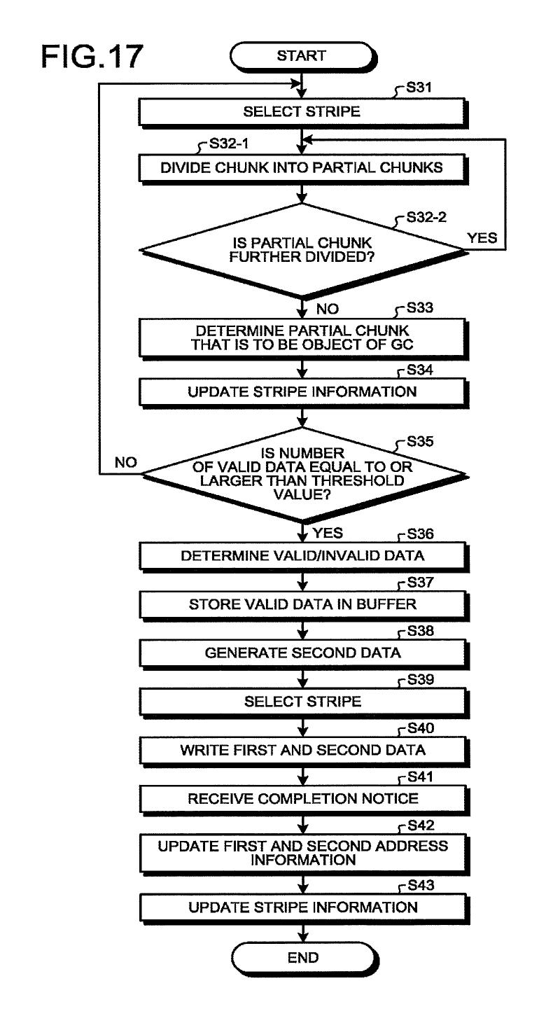

FIG. 17 is a flowchart illustrating an example of a garbage collection process according to Modified Example 2 of the embodiment. In Modified Example 2 of the embodiment, a process of step S32-2 is added to the garbage collection process (refer to FIG. 11) according to the embodiment.

First, the selector 14 selects a stripe that is to be a target of garbage collection (step S31). Next, the divider 16 divides the chunk included in the stripe selected by the process of step S31 into partial chunks (step S32-1).

Next, the divider 16 determines whether or not to further divide the partial chunk acquired by the process of step S32-1 (step S32-2). For example, in a case where the chunk size of the partial chunk acquired in the case of further dividing the partial chunk acquired by the process of step S32-1 is equal to or larger than the threshold value (the third threshold value), the divider 16 determines to further divide. In addition, for example, in a case where the data size of the stripe information or the number of entries is equal to or smaller than the threshold value, for example, the divider 16 determines to further divide the partial chunk acquired by the process of step S32-1.

In a case where the partial chunk is further divided (step S32-2, Yes), the process returns to step S32-1.

In a case where the partial chunk is not further divided (step S32-2, No), the process proceeds to step S33. The description of the processes of steps S33 to S43 is the same as the description of the garbage collection process according to the embodiment, and thus, the description will be omitted.

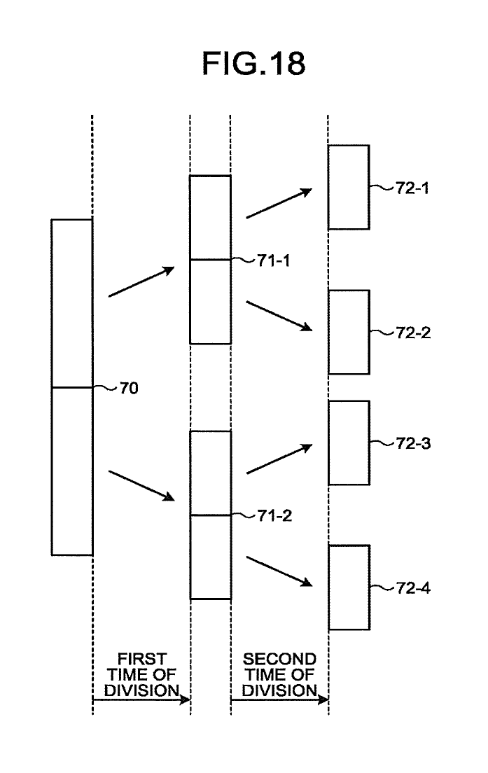

FIG. 18 is a diagram illustrating an example of division of chunks according to Modified Example 2 of the embodiment. In the example of FIG. 18, the case is illustrated where the divider 16 divides the chunk 70 into two partial chunks 71-1 and 71-2 and further divides the partial chunk 71-1 into two partial chunks 72-1 and 72-2 and divides the partial chunk 71-2 is divided into two partial chunks 72-3 and 72-4.

The divider 16 according to Modified Example 2 of the embodiment divides one stripe more finely than the divider 16 according to the embodiment. As a result, one stripe can be divided into a storage area having a relatively high update frequency (a partial chunk of which the number of valid data is equal to or smaller than a threshold value) and a storage area having a relatively low update frequency (a partial chunk of which the number of valid data is larger than the threshold value). Specifically, the storage controller 15 can generate the stripe including the first data having a relatively high update frequency by performing garbage collection on a stripe including partial chunks of which the number of valid data is equal to or smaller than a threshold value. In addition, the combiner 18 can generate a stripe including the first data having a relatively low update frequency by performing the above-described combination process on the partial chunk of which the number of valid data is larger than a threshold value.

According to the storage control device 100 according to Modified Example 2 of the embodiment, the locality of reference of the first data is further taken into consideration, so that it is possible to further ease the increase of the number of times of writing to the storages 11-1 to 11-n. As a result, it is possible to further extend the lifetime of the storages 11-1 to 11-n.

The function block (refer to FIG. 2) of the storage control device 100 according to the above-described embodiment and Modified Examples 1 and 2 may be realized by a program executed by one or more processors. The processor is, for example, a central processing unit (CPU).

The program executed by the storage control device 100 according to the embodiment is stored in a computer-readable recording medium such as a CD-ROM, a memory card, a CD-R, and a digital versatile disk (DVD) as a file in an installable format or an executable format and provided as a computer program product.

In addition, the program executed by the storage control device 100 according to the embodiment may be configured to be stored on a computer connected to a network such as the Internet and provided by being downloaded via the network. In addition, the program executed by the storage control device 100 according to the embodiment may be configured to be provided via a network such as the Internet without downloading.

In addition, the program to be executed by the storage control device 100 according to the embodiment may be configured to be incorporated in advance in a ROM or the like and provided.

The program executed by the storage control device 100 according to the embodiment has a module configuration including functions realizable by the program among the functional configurations of the storage control device 100 according to the embodiment.

The functions realized by the program is loaded on the main memory 3 by the processor 2 reading and executing the program from the recording medium such as the SSD 5. Namely, the functions realized by the program are generated on the main memory 3.

In addition, a portion of the functions of the storage control device 100 according to the embodiment may be realized by one or more hardware such as an integrated circuit (IC). The IC is, for example, a processor that executes dedicated processes. In addition, for example, the IC is a field-programmable gate array (FPGA).

In addition, in a case where functions are realized by using a plurality of processors, each processor may realize one of the functions or may realize two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage control device having, as a unit of storage, a stripe including one or more chunks being storage areas included in any of a plurality of storages, the storage control device comprising:
a first selector configured to select a stripe from a plurality of stripes on the basis of the number of one or more pieces of valid first data included in the stripe;
a divider configured to divide the chunk included in the stripe selected by the first selector into a plurality of partial chunks; and
a determiner configured to determine the partial chunk that is to be a target of garbage collection on the basis of the number of one or more pieces of the valid first data included in the partial chunk.

2. The storage control device according to claim 1, wherein the first selector selects the stripe in which the number of one or more pieces of the valid first data is equal to or smaller than a first threshold value from the plurality of stripes.

3. The storage control device according to claim 1, wherein the determiner determines, as a target of garbage collection, a partial chunk in which the number of one or more pieces of the valid first data included is equal to or smaller than a second threshold value among the plurality of partial chunks.

4. The storage control device according to claim 1, wherein
the divider divides the chunk included in the stripe selected by the first selector into two partial chunks, and
the determiner determines the partial chunk in which the number of one or more pieces of the valid first data is smaller than that of the other partial chunk as a target of garbage collection, and when the numbers of one or more pieces of the valid first data included in the two partial chunks are the same, the determiner determines one of the partial chunks as a target of garbage collection.

5. The storage control device according to claim 1, further comprising:
a generator configured to generate one or more pieces of second data for restoring the one or more pieces of the first data from a plurality of pieces of the first data;
a second selector configured to select the stripe storing the one or more pieces of the first data and the one or more pieces of second data; and
a storage controller configured to store the one or more pieces of the first data and the one or more pieces of second data in the chunk included in the stripe selected by the first selector.

6. The storage control device according to claim 5, wherein the storage controller determines at least one of a chunk storing the one or more pieces of the first data and a chunk storing the one or more pieces of the second data on the basis of states of the plurality of storages.

7. The storage control device according to claim 6, wherein the states of the plurality of storages are total write capacities of the plurality of respective storages.

8. The storage control device according to claim 6, wherein the states of the plurality of storages are ratios of total write capacities of the plurality of respective storages to capacities of the plurality of respective storages.

9. The storage control device according to claim 5, wherein the storage controller randomly determines at least one of a chunk storing the one or more first data and a chunk storing the one or more second data.

10. The storage control device according to claim 1, wherein the divider does not divide the chunk when a size of the partial chunk is less than a third threshold value.

11. The storage control device according to claim 1, wherein the divider repeats division of the partial chunk acquired by dividing while a size of the partial chunk acquired by being divided is equal to or larger than a third threshold value.

12. The storage control device according to claim 1, further comprising a combiner configured to combine a plurality of first stripes to a second stripe by copying the one or more pieces of the valid first data included in the plurality of first stripes including a chunk having a size being equal to or smaller than a fourth threshold value to the unused second stripe including a chunk having a size being equal to or larger than a fifth threshold value and deleting the plurality of first stripes.

13. A storage control method for a storage control device having, as a unit of storage, a stripe including one or more chunks being storage areas included in any of a plurality of storages, the storage control method comprising:
selecting a stripe from a plurality of stripes on the basis of the number of one or more pieces of valid first data included in the stripe;
dividing the chunk included in the stripe selected by the first selector into a plurality of partial chunks; and
determining the partial chunk that is to be a target of garbage collection on the basis of the number of one or more pieces of the valid first data included in the partial chunk.

14. A non-transitory computer readable recording medium with an executable program stored thereon, wherein the program, when executed by a computer having, as a unit of storage, a stripe including one or more chunks being storage areas included in any of a plurality of storages, instructs the computer to perform:
selecting a stripe from a plurality of stripes on the basis of the number of one or more pieces of valid first data included in the stripe;
dividing the chunk included in the stripe selected by the first selector into a plurality of partial chunks; and
determining the partial chunk that is to be a target of garbage collection on the basis of the number of one or more pieces of the valid first data included in the partial chunk.
